(19) United States
(12) Patent Application Publication
(10) Pub. No.: US 2015/0006441 A1
(43) Pub. Date: Jan. 1, 2015

(54) SERVICE CONTROL APPARATUS, SERVICE CONTROL METHOD AND COMPUTER READABLE MEDIUM

(71) Applicant: KABUSHIKI KAISHA TOSHIBA, Tokyo (JP)

(72) Inventors: Masaru SUZUKI, Kawasaki (JP); Kazuo SUMITA, Yokohama (JP); Hiroko FUJII, Tokyo (JP); Hiromi WAKAKI, Tokyo (JP); Michiaki ARIGA, Kawasaki (JP)

(21) Appl. No.: 14/490,709

(22) Filed: Sep. 19, 2014

Related U.S. Application Data
(63) Continuation of application No. PCT/JP2013/057570, filed on Mar. 12, 2013.

(30) Foreign Application Priority Data
Mar. 19, 2012 (JP) 2012-062849

(51) Int. Cl. G06N 5/04; G06F 17/30

(52) U.S. Cl. CPC G06N 5/04; G06F 17/30554
USPC 706/11

(57) ABSTRACT

According to one embodiment, a service control apparatus includes an acquisition unit, an estimator, and a generator. The acquisition unit acquires a user request. Intention knowledge items associate user requests with user intentions behind the user requests. The estimator estimates user an intention corresponding to the user request with reference to the intention knowledge items. Service control knowledge items define methods of generating service control conditions for operating the service. The methods correspond to the user intentions. The generator generates one of the service control conditions corresponding to the user request and the user intention, with reference to the service control knowledge items.

### CROSS-REFERENCE TO RELATED APPLICATIONS

This application is based upon and claims the benefit of priority from Japanese Patent Application No. 2012-062849, filed Mar. 19, 2012, the entire contents of which are incorporated herein by reference.

### FIELD

Embodiments described herein relate generally to a service control apparatus, a service control method and a computer readable medium.

### BACKGROUND

In service control apparatuses for operating machinery and various services, such as a web service, in accordance with user's input, it is necessary to analyze user's input information and provide a service just as the user intended.

There is a conventional technique of analyzing a user's intention from the input information and automatically adding a condition for operating various services. There is another conventional technique of causing a search device to generate a search formula based on user's initial input, and to reconstruct the search formula based on data associated with a search result and fed back from the user.

However, in these techniques, services are operated based on limited knowledge, such as the added condition and the data fed back from the user, which makes it difficult to provide an optimal result to the user's actually intended (but unconscious) purpose.

### BRIEF DESCRIPTION OF THE DRAWINGS

FIG. 1 is a block diagram illustrating a service control apparatus according to a first embodiment;

FIG. 2 is a block diagram illustrating the hardware configuration of the service control apparatus of the embodiment;

FIG. 3 is a flowchart illustrating the operation of the service control apparatus of the embodiment;

FIG. 4 is a view illustrating examples of intention knowledge items employed in the embodiment;

FIG. 5 is a view illustrating examples of preference knowledge items employed in the embodiment;

FIG. 6 is a flowchart used when the intentions in the embodiment are ranked;

FIG. 7 is a view illustrating an example of display of the intention knowledge employed in the embodiment;

FIG. 8 is a view illustrating examples of service control knowledge employed in the embodiment;

FIG. 9 is a view illustrating an example of an output from a search service, employed in the embodiment; and

FIG. 10 is a view illustrating an example of a display of intention knowledge employed in a modification of the embodiment.

### DETAILED DESCRIPTION

An embodiment and its modifications will be described with reference to the accompanying drawings.

It is an object of the embodiments to provide a service control apparatus for operating a service in consideration of a user's intended purpose.

In general, according to one embodiment, a service control apparatus for operating a service in accordance with a user request, includes a service request acquisition unit, an intention knowledge storage, an intention estimator, a service control knowledge storage, and a service control condition generator. The service request acquisition unit acquires the user request. The intention knowledge storage stores intention knowledge items which associate user requests with user intentions behind the user requests. The intention estimator estimates a user intention corresponding to the user request with reference to the intention knowledge items. The service control knowledge storage stores service control knowledge items which define methods of generating service control conditions for operating the service. The methods correspond to the user intentions. The service control condition generator generates one of the service control conditions corresponding to the user request and the user intention, with reference to the service control knowledge items.

### First Embodiment

A description will now be given of a service control apparatus according to a first embodiment, in which search associated with travel-related commercial items is performed based on an input that is made by a user using a natural language. The service control apparatus of the first embodiment searches a travel-related commercial item suitable for the intended purpose of the user utilizing an external search service, and presents it to the user.

Although in the embodiment, travel-related commercial items, such as lodging facilities, tour information, sightseeing information, will be described as search targets, the search targets are not limited to travel-related items. Further, although the service control apparatus of the embodiment operates external search services, the service as an operation target may be arbitrary application.

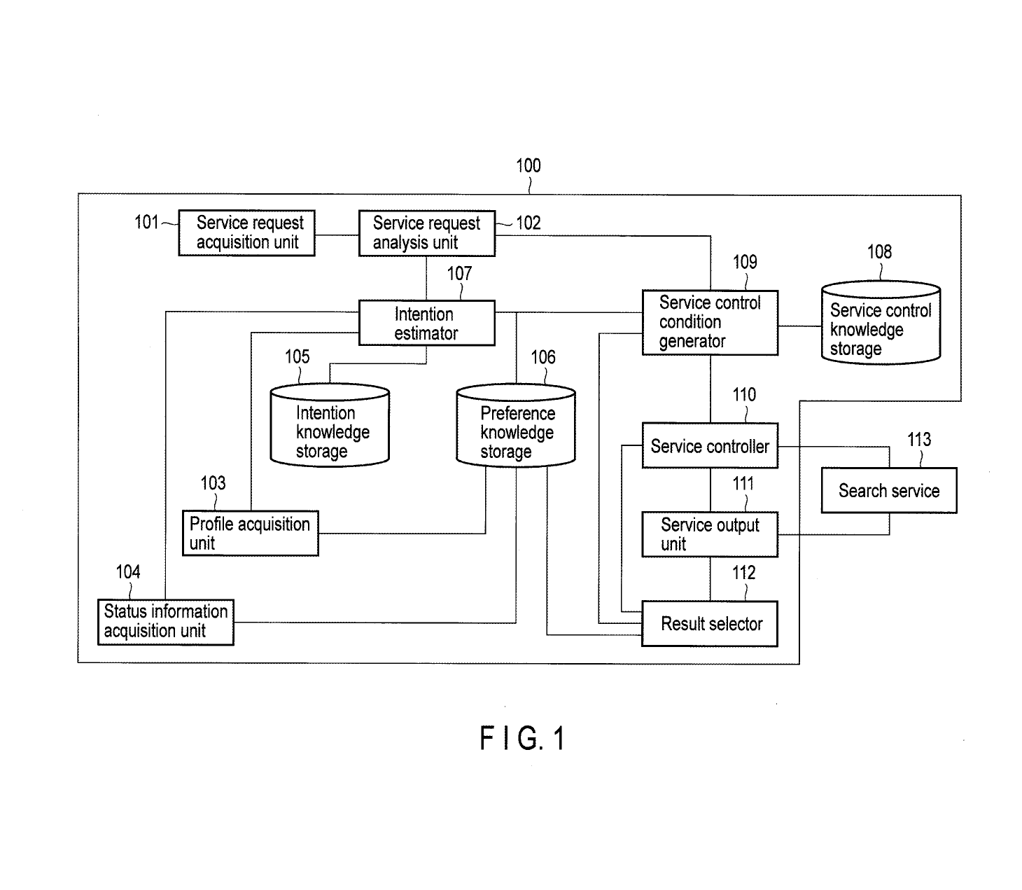

FIG. 1 is a block diagram illustrating the service control apparatus 100 of the first embodiment. The service control apparatus 100 comprises a service request acquisition unit 101, a service request analysis unit 102, a profile acquisition unit 103, a status information acquisition unit 104, an intention knowledge storage 105, a preference knowledge storage 106, an intention estimator 107, a service control knowledge storage 108, a service control condition generator 109, a service controller 110, a service output unit 111, and a result selector 112.

The service controller 110 and the service output unit 111 are connected to a search service 113 for searching via a network.

### Hardware Configuration

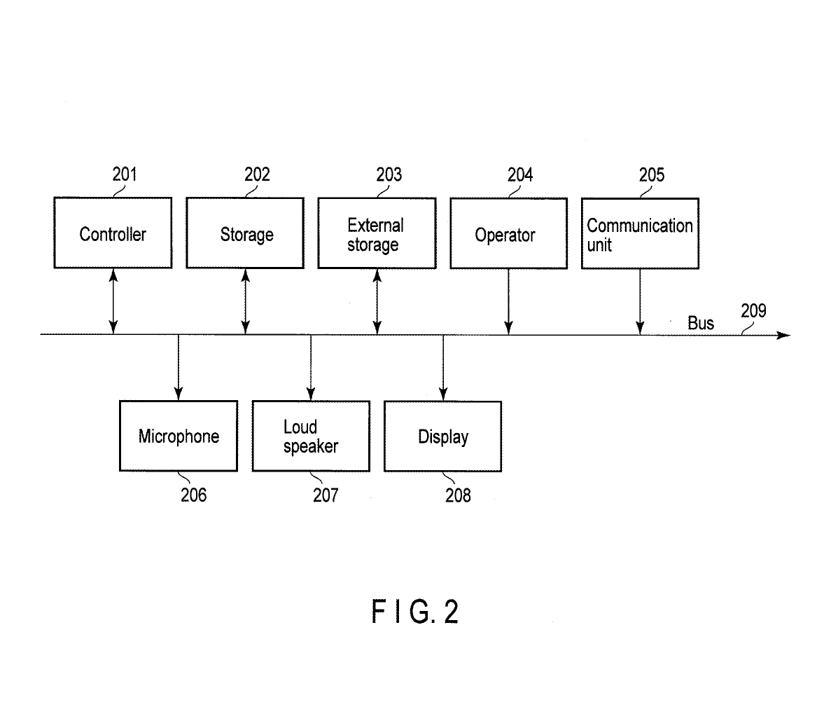

The service control apparatus of the embodiment is realized by hardware, such as a common computer terminal, as shown in FIG. 2. Specifically, the apparatus comprises a controller 201, such as a central processing unit (CPU), for controlling the entire apparatus, a storage 202, such as a read only memory (ROM) storing various types of data and various programs, and a random access memory (RAM), an external storage 203, such as a hard disk drive (HDD) for storing various types of data and various programs, and a compact disk (CD) drive, an operator 204, such as a keyboard, a mouse and a touch panel, a communication unit 205 for controlling communication with an external device, a microphone 206 for acquiring sound, a loud speaker 207 for generating synthesized sound, a display 208 for displaying images, and a bus 209 connecting these elements. The service control apparatus of the embodiment may be of a potable type or a fixed type.

In the above hardware configuration, the following functions are realized when the controller 201 executes various programs stored in the storage 202, such as the ROM, and the external storage 203.

### Function of Each Block

The service request acquisition unit 101 acquires, from the user, a request written in a natural language as text data, and sends it to the service request analysis unit 102. The user can input a request (service request) to the search service 113 via the keyboard of the operator 204. The service request can include, for example, a request that “User wants to go to beautiful sea.”

Alternatively, the apparatus may be modified such that the user can input the service request by directly inputting their voices. In this case, the voice acquired by the microphone 206 is transformed into text data by a known voice recognition technique.

The service request analysis unit 102 analyzes the service request received by the service request acquisition unit 101, transforms computer-readable data, and sends the resultant data to the intention estimator 107. The operation of the service request analysis unit 102 will be described later in detail.

The profile acquisition unit 103 acquires a user profile including age, career, sex, family structure, etc., and sends it to the intention estimator 107. The profile acquisition unit 103 may directly acquire the profile from the user via the keyboard of the operator 204, or may read a profile from a profile storage (not shown) that is realized by a known database or file system.

The status information acquisition unit 104 acquires information (status information) associated with a user status, such as date, time, user position, and user's behavior, and sends it to the intention estimator 107. The status information acquisition unit 104 may present, to the user, options associated with user position, behavior, etc., thereby enabling them to select the options via the operator 204.

Alternatively, the status information acquisition unit 104 may read information associated with the user status, using a known status sensing technique, such as a GPS or an acceleration sensor (not shown). For instance, if the user pre-registers position information associated with their houses, whether the user is at home can be determined from position information sent from the GPS, or whether the user is at rest, walking or riding can be determined from the waveform of the acceleration sensor indicating changes in acceleration.

The intention knowledge storage 105 stores a plurality of service requests, and a plurality of intention knowledge items for associating the service requests with the intentions that exist behind the service requests. For instance, the fact that there is an intention of “going to the sea” behind a service request requesting that “User wants to go to beautiful sea” is stored as intention knowledge. The intention knowledge storage 105 also stores the relationship between intention knowledge items themselves. By virtue of this structure, it can be detected, for example, that the intention of “going to the sea” is associated with the intention of “having a leisurely time in a resort.” This enable the intention estimator 107, described later, to estimate the user's intended purpose that cannot be detected only from the service request.

The intention knowledge storage 105 can be realized by the storage 202 or the external storage 203. The intention knowledge storage 105 will be described later in detail.

The preference knowledge storage 106 stores preference knowledge that associates profiles with the intention knowledge and also associates the status information with the intention knowledge. For instance, the preference knowledge includes information indicating that a user having a profile “presence/absence of child=presence” has a strong intention of “playing with a child.” By virtue of this information, the intention estimator 107, described later, can estimate the intention of the user in consideration of the user's profile and status information.

The preference knowledge storage 106 can be realized by the storage 202 or the external storage 203. The preference knowledge storage 106 will be described later in detail.

The intention estimator 107 searches the intention knowledge storage 105 for intention knowledge, using the service request transformed by the service request analysis unit 102, thereby estimating the user intention corresponding to a user request, based on the searched intention knowledge.

If a plurality of intentions are estimated, the intention estimator 107 searches the preference knowledge storage 105 for the preference knowledge items corresponding to the estimated intentions, and calculates a preference score that indicates the degree by which the search service 113 is utilized for each intention, based on the searched preference knowledge, the user profile received from the profile acquisition unit 103, and the status information received from the status information acquisition unit 104. Based on the preference score, the estimated intentions are ranked.

The intention estimator 107 sends the estimated intentions to the service control condition generator 109. When a plurality of estimated intentions exist, the intention of the highest rank may be sent to the service control condition generator 109.

Alternatively, the intensions of all ranks or a predetermined number of intentions from the intention of the highest rank may be presented to the user, and the intention selected by the user be sent to the service control condition generator 109.

The service control knowledge storage 108 stores service control knowledge in which a method of generating a service control condition as a condition for operating the search service 113 is described for each user intention. For instance, in the case of searching for a travel-related commercial item, the service control knowledge is information that associates user's purpose of travel with a search condition that includes, for example, the type of guest room, presence/absence of ancillary facilities: and a keyword in an introduction sentence. The service control knowledge storage 108 can be realized by the storage 202 or the external storage 203. The service control knowledge storage 108 will be described later in detail.

The service control condition generator 109 utilizes the intention information received from the intention estimator 107 to search the service control knowledge storage 108 for service control knowledge, and then to generate a service control condition based on the searched service control knowledge and the user request. The generated service control condition is sent to the service controller 110. The service control condition generator 109 will be described later in detail.

The service controller 110 uses the service control condition received from the service control condition generator 109 to operate the search service 113.

The service output unit 111 receives an output or outputs from the search service 113, and presents them to the user via the display 208.

The result selector 112 accepts a user operation on the output(s) of the service output unit 111. If a plurality of outputs exit, the result selector 112 detects which one of the outputs is selected by the user.

### Flowchart

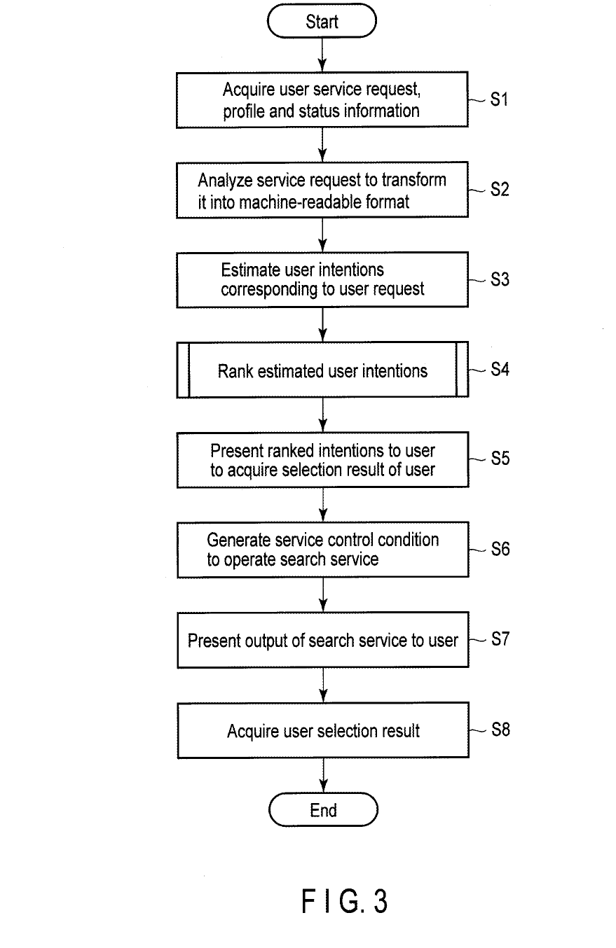

Referring now to the flowchart of FIG. 3, processing performed in the service control apparatus of the embodiment will be described.

At step S1, the service request acquisition unit 101 acquires a user service request. In the embodiment, assume that text data “User wants to go to beautiful sea” is acquired as the user service request.

The profile acquisition unit 103 acquires a user profile. The user profile includes, for example, age, career, sex, presence/absence of partner, and presence/absence of child. In the embodiment, assume that a user profile “age=25, career=company worker, sex=man, presence/absence of partner=presence, presence/absence of child=presence, and age of child=NA” has been acquired. “NA” indicates that no value has been acquired.

The profile acquisition unit 103 may be constructed to store, in a first loop of processing, an acquired profile in the storage 202 or the external storage 203, and to access the user in a second loop to confirm that there is no change in the stored profile.

The status information acquisition unit 104 acquires user status information. The user status information includes date, time, user position, user behavior, etc.

The user position information can be acquired from a GPS (not shown) installed in the service control apparatus 100. In the embodiment, assume that it is detected that the user is at home in Kawasaki city pre-registered, and “position=home (Kawasaki city)” is already acquired as user status information.

At step S2, the service request analysis unit 102 analyzes the user service request to transform the request into a machine-readable format.

More specifically, the service request analysis unit 102 transforms the text data “User wants to go to beautiful sea” into a morpheme sequence, utilizing a known morpheme analysis technique. As a result, analysis information “User <subject>+wants <verb (want)>+to go <infinitive>+to <preposition>+beautiful <adjective>+sea <noun>” is obtained. The character strings marked with “<>,” such as “<noun>,” represent articles, and the character string marked with “( )” such as “(want),” represents the basic form of a word.

Utilizing a known intrinsic representation extraction technique, the service request analysis unit 102 assigns meaning classes to nouns, proper nouns and unknown words resulting from morpheme analysis. In the embodiment, as a result of unique-expression extraction, information “User <subject>+wants <verb (want)>+to go <infinitive>+to <preposition>+beautiful <adjective>+sea <noun: geographical name class>” is obtained. The “geographical name class” represents an intrinsic representation class. Intrinsic representation classes include “geographical name,” “commercial item class,” “commercial item name,” “menu class,” “menu name,” etc., as well as the “geographical name class.” The “geographical name” is a class representing a specific geographical name, such as “Kawasaki city,” and the “geographical name class” is a class representing a general geographical name, such as “sea” or “mountain.” The same relationship exists between the “commercial item class” and the “commercial item name,” and between “menu class” and “menu name.”

The service request analysis unit 102 transforms a service request into a machine-readable format based on an intrinsic representation extraction result. Assume here that formats, such as <target=“noun”>, <target class=“intrinsic representation class”>, <action=“verb: basic form”> and <others=“self-sufficient word: basic form/word stem”>, are possible as the machine-readable formats of the service request. In these formats, the target, target class, action, etc., indicate attribute names, and the parts indicated by the quotation marks “ ” are attribute values and indicate extraction of corresponding character strings from the intrinsic representation results. In the embodiment, using these formats, the user service request is transformed into the information including “target=sea,” “target class=geographical name class,” “action=go” and “others=beautiful.” If a complex service request other than a single sentence is input, it can be dealt with by dependency parsing or correspondence parsing.

At step S3, the intention estimator 107 estimates the intention of the user corresponding to the user request. Specifically, the intention estimator 107 estimates the intention of the user corresponding to the user request by searching the intention knowledge storage 105 for intention knowledge using the service request transformed by the service request analysis unit 102.

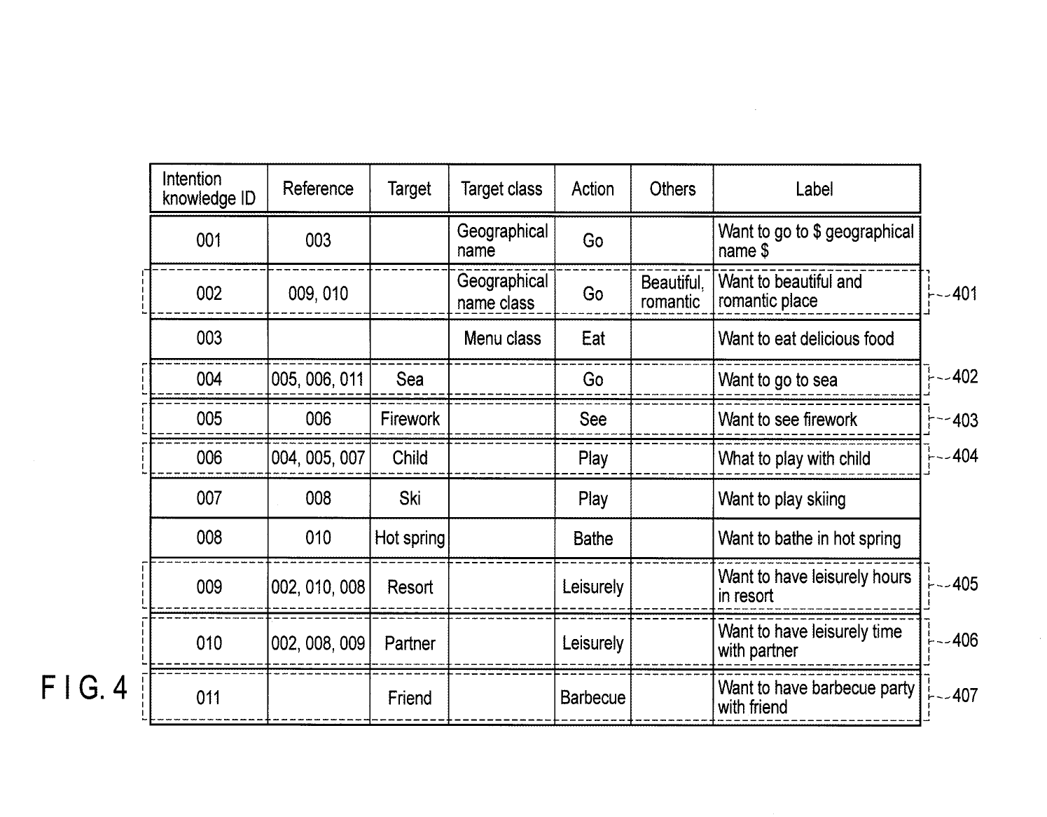

FIG. 4 shows examples of intention knowledge stored in the intention knowledge storage 105. In the figure, “intention knowledge ID” is a unique ID for identifying each intention knowledge item, “association” is intention knowledge ID assigned to another associated intention knowledge item, “target” is a specific matter indicating an intention knowledge target, “target class” is a general class indicating an intention knowledge target, “action” is an action corresponding to the intention knowledge, “others” indicate attribute values other than the aforementioned one, and “label” is a label used to present intention knowledge to the user. In the “label” attribute, the character string marked with “$” and “$,” such as “$ geographical name $, is transformed into a specific character string of a class included in the service request, when it is presented to the user. In the embodiment, the attribute value in the attribute “label” indicates the intention of the user estimated by the intention estimator 107.

For instance, if the intention knowledge ID is “001,” it indicates the action of “going” to a place named an arbitrary “geographical name.” More specifically, it represents a user intention of “going to Kyoto.”

Similarly, an intention knowledge ID of “003” indicates a user intention of “eating” a menu included in “menu class,” such as “Italian food” or “buckwheat noodle.” If thus, the intention knowledge ID of “001” is related to the intention knowledge ID of “003,” this expresses that it is possible that the real intention of going to Kyoto in the user request will be “eating delicious food.”

In the embodiment, intention knowledge items are supposed to be stored, as well as those shown in FIG. 4.

The intention knowledge may be designed by a system designer or developer based on service element analysis. Alternatively, it may be generated automatically or semi-automatically by analyzing a large amount of text on the Internet. For instance, in the embodiment, by subjecting, to syntactic parsing, a description, such as “we went to the sea to see a firework” or “we went swimming in the sea to give a child a fantastic time”, that can be collected from a diary or travel sketch in an Internet blog, an intention of seeing a firework (ID 005) or playing with a child (ID 006) can be extracted from an action of going to the sea (ID 004), and these intentions can be associated with each other.

The intention knowledge storage 105 can be realized by, for example, a known relational database technique.

In the intention knowledge search, the attribute name and the attribute value of the service request transformed by the service request analysis unit 102 are used as search conditions. The intention estimator 107 searches for intention knowledge items in which the attribute values of the “targets” or “target classes” coincide with each other, and the attribute values of “action” coincide with each other. In the embodiment, since the attribute value of the attribute name “target” indicates “sea,” the attribute value of the attribute name “target class” indicates “geographical name class,” and the attribute value of the attribute name “action” indicates “go,” intention knowledge items 401 and 402 in FIG. 4 are extracted.

The intention estimator 107 also extracts related intention knowledge. In the embodiment, referring to the “association” sections in the intention knowledge items 401 and 402, intention knowledge items 403 to 407 are also extracted.

By the above processing, the intention estimator 107 estimates, as the user intentions, the attribute values in the “label” sections of the intention knowledge items 401 to 407.

At step S4, the intention estimator 107 ranks the user intentions estimated at step S3. More specifically, the intention knowledge items are ranked so that the intentions suitable to the user profile and the status information acquired at step S1 are ranked in higher places. At this time, the intention estimator 107 utilizes the preference knowledge stored in the preference knowledge storage 106. Further, note that if it is determined at step S3 that only one user intention is estimated, step S4 can be skipped over.

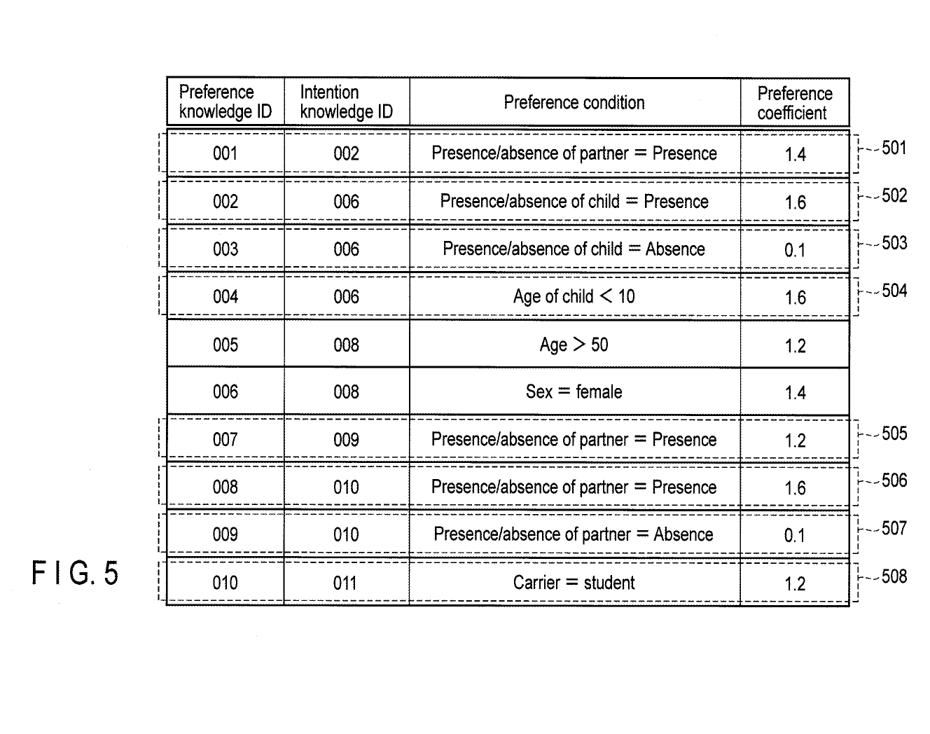

FIG. 5 shows examples of intention knowledge stored in the preference knowledge storage 106. In the figure, “preference knowledge ID” is a unique ID for permitting the preference knowledge storage 106 to identify each preference knowledge item, “preference knowledge ID” is the ID of the intention knowledge item corresponding to said each preference knowledge item, “preference condition” is a condition for a user profile or status information used when determining whether said each preference knowledge item is applied, and “preference coefficient” is an index indicating with what a degree of easiness, the intention knowledge item can be selected by a user who satisfies the preference condition.

For instance, if the preference knowledge ID is “002,” the corresponding intention knowledge ID is “006.” The intention knowledge ID of “006” indicates that the case where the user profile includes the condition of “presence/absence of child=presence” can be easily selected 1.6 times the case where the user profile does not include the same.

The preference knowledge can be created by a designer/developer initially from a service requirement. For example, in the case of travel-related commercial items, in view of supposed target clients for the respective commercial items, it can be designed such that a high preference coefficient is imparted to the preference condition of “presence/absence of child=presence” in, for example, a hotel having guest rooms for the people with children, or that a high preference coefficient is imparted to a preference condition of “age>50” in senior-oriented tours. As will be described later, the preference knowledge is updated based on actual use by users.

The preference knowledge storage 106 is realized by, for example, a known relational database technique.

The intention estimator 107 searches for a target preference knowledge item, based on the intention knowledge IDs estimated at step S3. In the embodiment, items 501 to 508 in FIG. 5 are extracted.

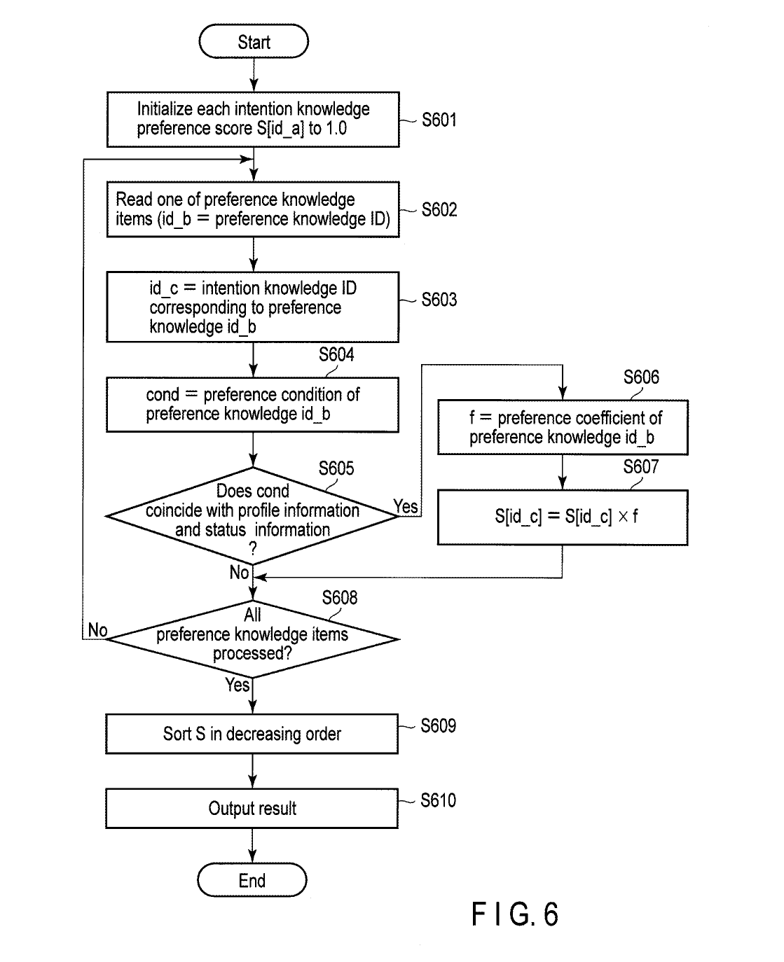

Referring then to the flowchart of FIG. 6, a detailed description will be given of the process of ranking user intentions.

At step S601, a variable S[id_a] indicating the preference score of each intention knowledge item is defined and set to an initial value of 1.0, where id a indicates the intention knowledge ID of each intention knowledge item extracted from the intention knowledge storage 105.

At step S602, one item is read from the preference knowledge items extracted from the preference knowledge storage 106. The preference knowledge ID of the read preference knowledge item is substituted into a variable id_b.

At step S603, the intention knowledge ID corresponding to the preference knowledge item of the preference knowledge ID=id_b is substituted into id_c.

At step S604, the value of a preference condition for the preference knowledge item of the preference knowledge ID=id_b is substituted into a variable “cond.”

At step S605, the user profile and status information are referred to, thereby determining whether the preference condition is “true.”

At step S606, if the answer at step S605 is “true,” the preference coefficient of the preference knowledge item with the preference knowledge ID=id_b is substituted into a variable f, and at step S607, the preference score is updated as S[id_c]=S[id_c]×f.

At step S608, the above process is iterated for all preference knowledge items extracted from the preference knowledge storage 106.

At step S609, the resultant variable values S[id_a] are sorted in a decreasing order after all preference knowledge items are processed.

At step S610, the intention knowledge IDs corresponding to the variable values S[id_a] are output in the order corresponding to the sorted preference knowledge items.

For instance, an intention knowledge item 401 will have a preference score=1.4 (1.0×1.4) in accordance with a preference knowledge item 501. Further, an intention knowledge item 404 will have a preference score=0.1 (1.0×0.1) since it coincides with a preference knowledge item 503, although it does not coincide with a preference knowledge item 502 or 504. Similarly, an intention knowledge item 405 will have a preference score=1.2 (1.0×1.2) since it coincides with a preference knowledge item 505. An intention knowledge item 406 will have a preference score 32 1.6 (1.0×1.6) since it coincides with a preference knowledge item 506, although it does not coincide with a preference knowledge item 507. An intention knowledge item 407 does not coincide with a preference knowledge item 508 and therefore will have a preference score=1.0 (initial value). Further, intention knowledge items 402 and 403 have no corresponding preference knowledge in FIG. 5, and are therefore set to the preference score of 1.0 (initial value).

As a result, the intention knowledge items are ranked in the order of 406, 401, 405, 402, 403, 407 and 404, if no particular consideration is given to the case where some intention knowledge items have the same score. Using this ranking result, the intention estimator 107 can rank the estimated user intentions.

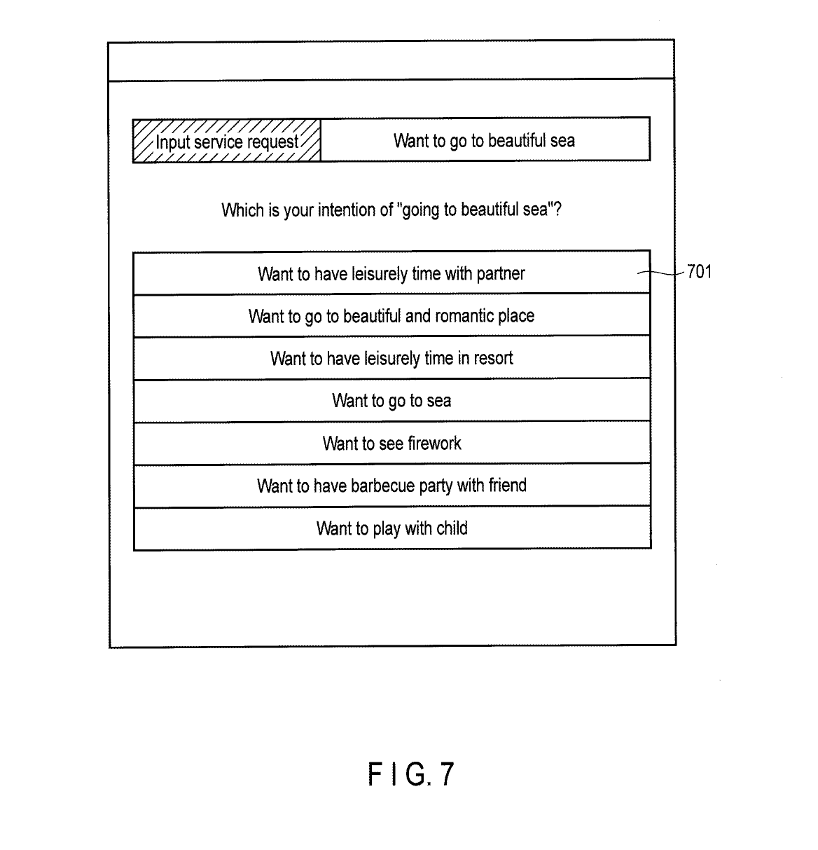

Returning to the flowchart of FIG. 3, at step S5, the intention estimator 107 presents, to the user, the intentions ranked at step S4 to acquire the optimal intention selected by the user. FIG. 7 shows examples of intentions displayed on the display 208. To display the intentions, the “label” attribute shown in FIG. 4 is utilized.

Although in the embodiment, all intentions corresponding to the seven intention knowledge items extracted from the intention knowledge storage 105 are displayed, only intention knowledge items of higher ranks or only intention knowledge items with a preference score of 1 or more may be displayed.

In the examples of FIG. 7, it is assumed that the user has selected an intention 701 as an optimal one via the operator 204. The intention estimator 107 provides the service control condition generator 109 and the preference knowledge storage 106 with the intention knowledge item 406 corresponding to the selected intention 701 and the profile and status information acquired at step S1.

At step S6, the service control condition generator 109 generates a service control condition for operating the search service 113, based on the service request transformed at step S2 and the intention selected by the user at step S5.

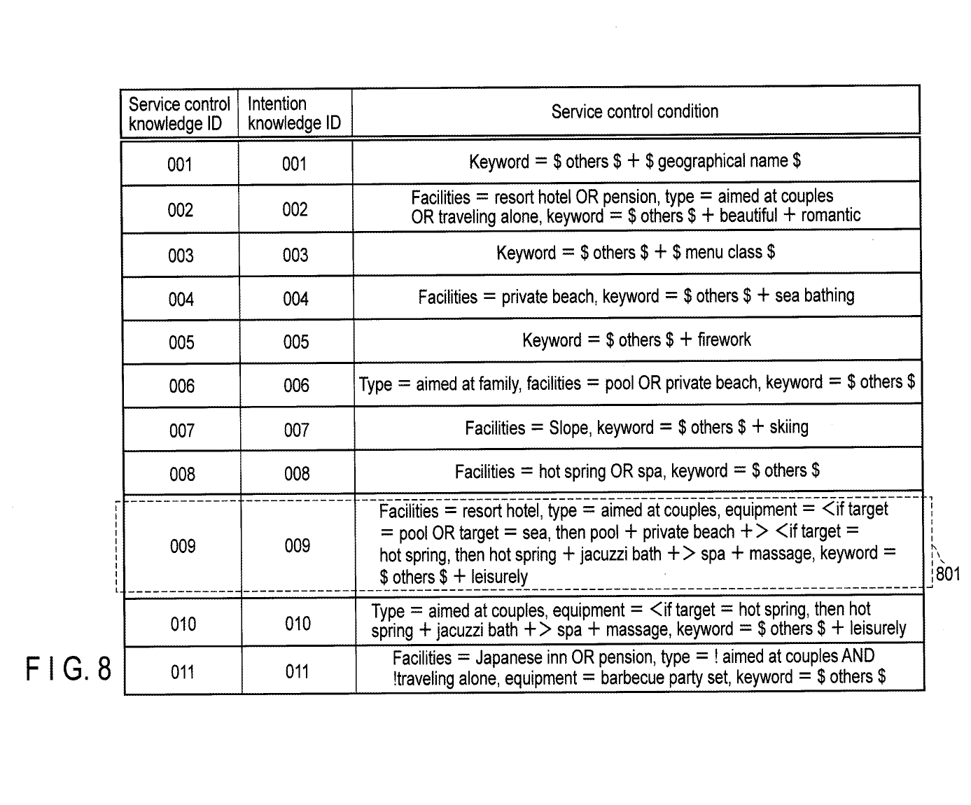

FIG. 8 shows examples of service control knowledge stored in the service control knowledge storage 108. The service control knowledge storage 108 can be realized by, for example, a known relational database technique. The intention knowledge storage 105, the preference knowledge storage 106, and the service control knowledge storage 108 may be made to operate on the same relational database management system.

The service control knowledge is beforehand prepared for each service to be operated. For instance, a service control condition 801 shown in FIG. 8 is suitable for searching for a travel-related commercial item corresponding to an intention knowledge ID=009 (“User wants to have leisurely hours in a resort”), and can be created by a designer/developer or a worker of a travel-related commercial item search service, based on an assumed search condition (such as a condition for attributes or keywords) acceptable by the travel-related commercial item search service. In the shown example, assume that the service control condition 801 has been extracted based on the intention knowledge ID of “009” selected by the user at step S5.

Based on the attribute value of the “control condition” corresponding to the extracted service control knowledge 801, the service control condition generator 109 generates a search control condition in accordance with a service request “target=sea, target class=geographical name class, action=go, others=beautiful,” which is transformed into a machine-readable form, and a profile “age=25, career=company worker, presence/absence of partner=presence, sex: man, presence/absence of child=presence, and age of child=NA,” and status information “position=home.”

The expression <if X=a, then b> included in the “control condition” means that if the value of the attribute “X” of the service request, the profile information and the status information is “a,” “b” is added to the control condition. “OR” means that if one of the conditions for a plurality of attributes associated therewith is satisfied, the condition is “true.” Further, the expression “$ others $” means that the value of the corresponding attribute (in this case, “others”) in the service request, the profile, and the status information is added to the search control condition.

In the embodiment, the service control condition generator 109 generates a service control condition of “facilities=resort hotel, type=aimed at couples, equipment=pool+private beach+spa+massage, keyword=beautiful+leisurely.”

In the embodiment, the service control condition is generated also using the user profile and the status information. However, if these information items cannot be acquired, the service control condition is generated using the service request only.

The service controller 110 sends the generated service control condition to the search service 113. As a result, the search service 113 is operated in accordance with the service control condition. The search service 113 in the embodiment is a known service that can be accessed through, for example, the Internet. The service controller 110 also sends the generated service control condition to the service output unit 111.

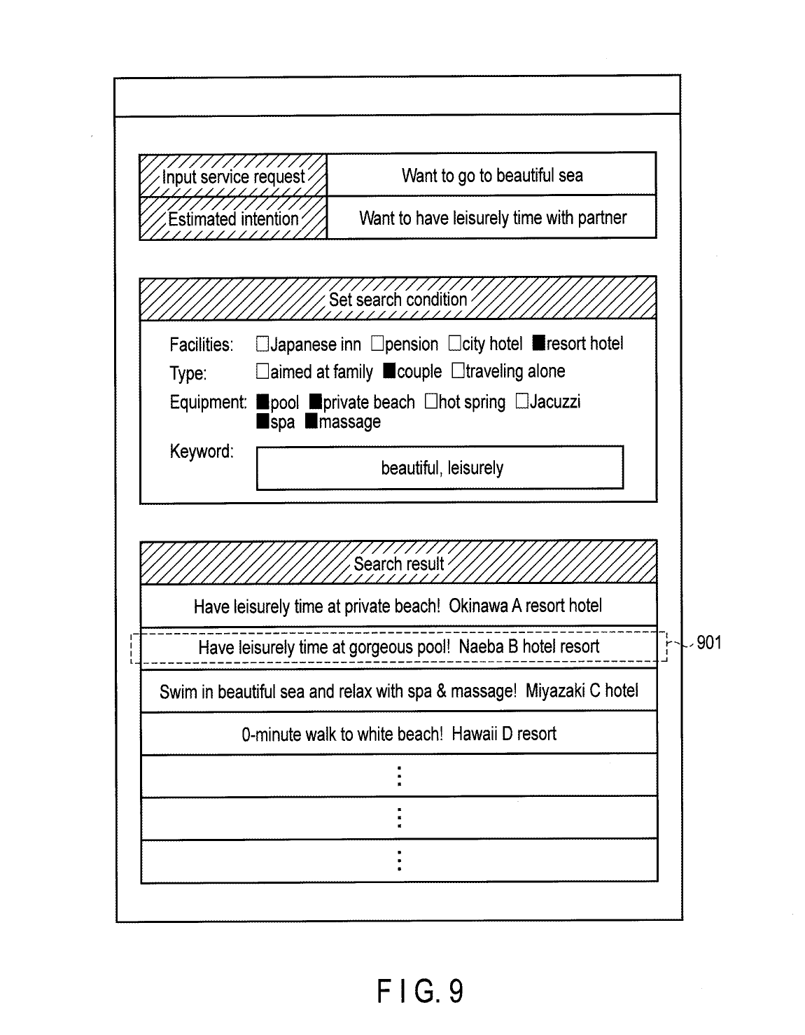

At step S7, the service output unit 111 receives an output from the search service 113 operated under the service control condition, and presents it to the user as shown in FIG. 9.

In the embodiment, the search service 113 to be operated is assumed to be aimed at travel-related commercial items. Accordingly, the output of the search service 113 is a travel-related commercial item list that coincides with the service control condition. Although FIG. 9 shows a list of indexes of search results, the service control condition is not always collated with index portions.

At step S8, the result selector 112 acquires a user selected result from the output of the search service 113 presented by the service output unit 111. If the user judges that there is no appropriate result, the result selector 112 instructs the service control condition generator 109 to modify the service control condition. The modification of the service control condition may be performed by presenting already generated service control conditions to the user, or by moderating the service control condition in accordance with a predetermined criterion. As the criterion for moderating the service control condition, deletion of a keyword (e.g., the word “leisurely” included in the service control condition 801), which is not designated by the user, may be exemplified.

Assume here that an item 901 in FIG. 9 is selected. Upon receiving the selection result, the service controller 110 sends it to the search service 113, and guides the user to the search service 113 to enable the user to directly use the search service 113.

Further, upon receiving the selection result, the preference knowledge storage 106 modifies the preference coefficient of the intention knowledge received from the intention estimator 107, assuming that the received intention knowledge served to provide an appropriate service to the user based on the user profile and the status information acquired at step S1. In this embodiment, the preference coefficient of the one of the preference knowledge items 506 and 507 corresponding to the intention knowledge item 406, which has a preference condition that coincides with the user profile and the status information, is modified to increase by, for example, being multiplied by a constant greater than 1.

### Advantage

In the service control apparatus of the embodiment, a user intention corresponding to a user request is estimated, utilizing intention knowledge that associates the request with the intention behind the request. This enables a service to be operated in view of the intended purpose of the user.

In the above-mentioned case, although the initial user service request was that “the user wants to go to beautiful sea,” the search control apparatus of the embodiment estimated that the user's real intention is to “stay leisurely with a partner,” and generated a service control condition based on the estimated intention. As a result, the user detected that “a resort hotel with a gorgeous pool” was preferable to “beautiful sea.” Thus, the user could have reached a result that could not have been reached based on the initial request only.

Further, the search control apparatus of the embodiment utilizes the preference knowledge that associates the profile with the intention knowledge and associates the status information with the intention knowledge, to estimate the user intention corresponding to the user request. Since thus, the user intention is estimated in view of not only the service request but also the user profile and the status information, an intention close to the real intention of the user can be estimated.

In addition, in the search control apparatus of the embodiment, the preference knowledge stored in the preference knowledge storage 106 is updated in accordance with the user selection result associated with the output of the search service 113. As a result, the intention estimator 107 can estimate an intention close to the user's real intention when the user reuses the search service 113.

### Modification 1

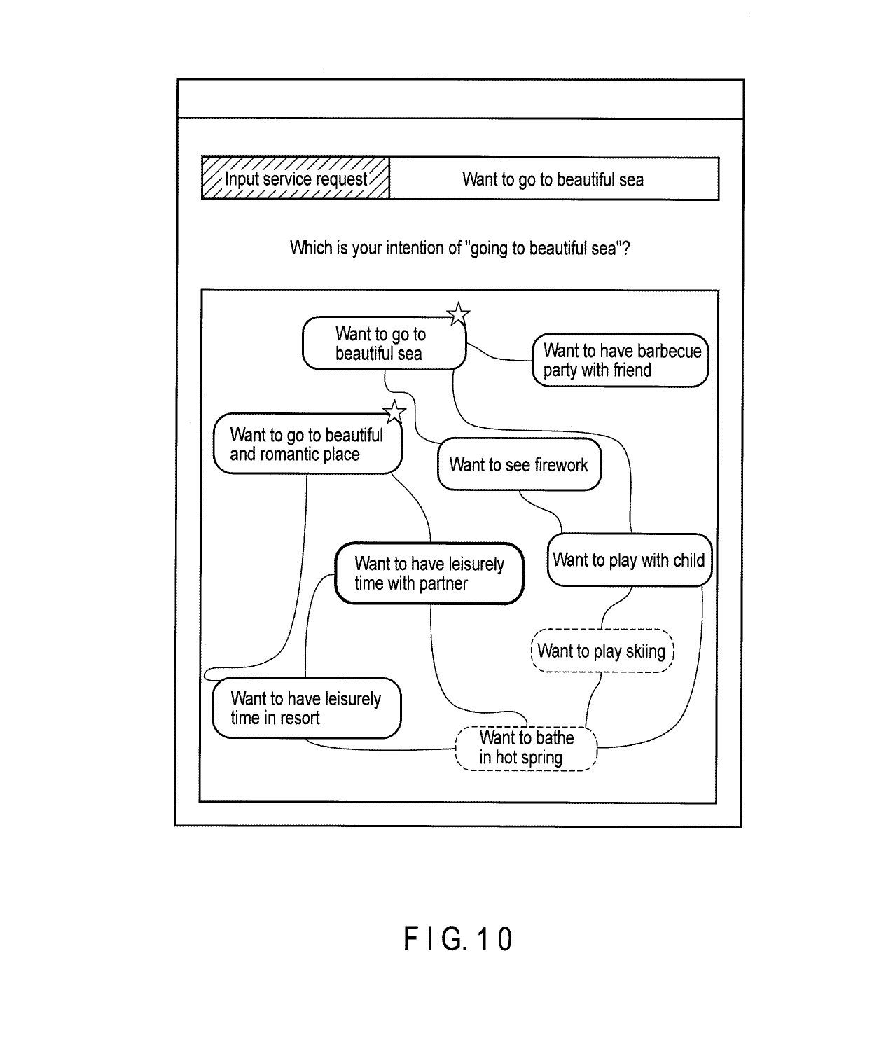

The intention estimator 107 may present the relationship between intention knowledge items to the user, as is shown in FIG. 10. In FIG. 10, mark “⋆” is attached to the intention(s) that can be directly extracted from the service request input by the user, and an intention of a high preference score is enclosed by the thick line. Further, in FIG. 10, the intentions indicated by intention knowledge items extracted through a plurality of steps concerning “associated” attributes in intention knowledge are enclosed by the broken lines, unlike FIG. 7. When a large number of intention knowledge items are stored in the intention knowledge storage 105, the user may further trace associated intention knowledge items while moving the display screen up, down, left and right.

### Modification 2

Although in the above-described embodiment, the search service 113 is installed in an external terminal, the structure is not limited to this. For instance, the search service 113 may be installed in the service control apparatus 100.

Although in the above-described embodiment, the service control apparatus 100 is realized by one terminal, the structure is not limited to this. The service control apparatus 100 may comprise a plurality of terminals. In this case, the above-mentioned elements (the service request acquisition unit 101, the service request analysis unit 102, the profile acquisition unit 103, the status information acquisition unit 104, the intention knowledge storage 105, the preference knowledge storage 106, the intention estimator 107, the service control knowledge storage 108, the service control condition generator 109, the service controller 110, the service output unit 111, and the result selector 112) may be incorporated in any of the terminals. Further, in this case, information may be transmitted between the terminals by radio communication or wired communication.

### Modification 3

Although in the above-described embodiment, the user profile and the status information are utilized to rank a plurality of intentions estimated by the intention estimator 107, the intention estimator 107 can be operated without using the profile or the status information, when the estimation result is presented to the user without ranking.

Part or all of the functionality of the embodiment can be realized by processing based on software.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A service control apparatus for operating a service in accordance with a user request, comprising:
a service request acquisition unit configured to acquire the user request;
an intention knowledge storage configured to store intention knowledge items which associate user requests with user intentions behind the user requests, the user intentions being hidden intentions that even a user is unconscious of;
an intention estimator configured to estimate a user intention corresponding to the user request with reference to the intention knowledge items;
a service control knowledge storage configured to store service control knowledge items which define methods of generating service control conditions for operating the service, the methods corresponding to the user intentions; and
a service control condition generator configured to generate one of the service control conditions corresponding to the user request and the user intention, with reference to the service control knowledge items.

2. The apparatus according to claim 1, further comprising:
a service controller configured to operate the service using the service control conditions generated by the service control condition generator.

3. The apparatus according to claim 1, wherein
the intention knowledge storage stores relationship between the intention knowledge items; and
the intention estimator utilizes the relationship to estimate the user intention corresponding to the user request.

4. The apparatus according to claim 2, further comprising:
a profile acquisition unit configured to acquire user profiles;
a status information acquisition unit configured to acquire user status information items; and
a preference knowledge storage configured to store preference knowledge items which associate the user profiles with the intention knowledge items, and associate the status information items with the intention knowledge items,
wherein the intention estimator estimates the user intention corresponding to the user request, referring to the user profiles, the user status information items and the preference knowledge items.

5. The apparatus according to claim 4, wherein the user profiles each comprise one of a user age, a user career, a user sex, and a user family structure.

6. The apparatus according to claim 4, wherein the status information items each comprise one of a date, a time, a user position and a user behavior.

7. The apparatus according to claim 4, further comprising:
a service presenting unit configured to present, to a user, an output of the service operated by the service controller; and
a result selector configured to acquire a user selection result concerning the output of the service,
wherein the preference knowledge items stored in the preference knowledge storage are updated in accordance with the user selection result.

8. A service control method of operating a service in accordance with a user request, comprising:
estimating a user intention corresponding to the user request with reference to intention knowledge items, the user intention being a hidden intention that even a user is unconscious of; and
generating one of service control conditions corresponding to the user request and the user intention, with reference to service control knowledge items which define methods of generating service control conditions for operating the service, the methods corresponding to the user intentions.

9. The method according to claim 8, further comprising:
operating the service using the service control conditions.

10. The method according to claim 8, wherein the estimating the user intention utilizes relationship between the intention knowledge items to estimate the user intention corresponding to the user request.

11. The method according to claim 9, further comprising:
acquiring user profiles; and
acquiring user status information items,
wherein the estimating the user intention estimates the user intention corresponding to the user request, referring to the user profiles, the user status information items and preference knowledge items which associate the user profiles with the intention knowledge items, and associate the status information items with the intention knowledge items.

12. The method according to claim 11, wherein the user profiles each comprise one of a user age, a user career, a user sex, and a user family structure.

13. The method according to claim 11, wherein the status information items each comprise one of a date, a time, a user position and a user behavior.

14. The method according to claim 11, further comprising:
presenting, to a user, an output of the service operated; and
acquiring a user selection result concerning the output of the service,
wherein the preference knowledge items are updated in accordance with the user selection result.

15. A computer readable medium including computer executable instructions, wherein the instructions, when executed by a service control apparatus for operating a service in accordance with a user request, cause the apparatus to execute a method comprising:
estimating a user intention corresponding to the user request with reference to intention knowledge items, the user intention being a hidden intention that even a user is unconscious of; and
generating one of service control conditions corresponding to the user request and the user intention, with reference to service control knowledge items which define methods of generating service control conditions for operating the service, the methods corresponding to the user intentions.
